(19) United States
(12) Patent Application Publication
(10) Pub. No.: US 2026/0299781 A1
(43) Pub. Date: Oct. 1, 2026

(54) SYSTEM AND METHOD FOR PREFETCHING DATA

(71) Applicant: Samsung Electronics Co., Ltd., Suwon-si (KR)

(72) Inventors: Jing YANG, Glen Allen, VA (US); Ho Bin LEE, San Jose, CA (US); Rekha PITCHUMANI, Oak Hill, VA (US)

(21) Appl. No.: 19/275,975

(22) Filed: Jul. 21, 2025

Related U.S. Application Data
(60) Provisional application No. 63/781,165, filed on Mar. 31, 2025.

(51) Int. Cl. G06F 3/06

(52) U.S. Cl. CPC G06F 3/061; G06F 3/0659; G06F 3/0673

(57) ABSTRACT

A system and method for prefetching data. In some embodiments, a method includes: receiving a first read command, the first read command including a first address; receiving a second read command, the second read command including a second address; determining, based on the first address and the second address, that the second read command is a command of a sequence having a first stride; and based on determining that the second read command is a command of a sequence having a first stride, prefetching a first data unit from a first memory to a second memory, the first memory having a first read granularity, and the second memory having a second read granularity, different from the first read granularity.

### CROSS-REFERENCE TO RELATED APPLICATION(S)

The present application claims priority to and the benefit of U.S. Provisional Application No. 63/781,165, filed Mar. 31, 2025, entitled “A Solution Architecture For High Bandwidth NAND Under Member Interface”, the entire content of which is incorporated herein by reference.

### FIELD

One or more aspects of embodiments according to the present disclosure relate to computing systems, and more particularly to a system and method for prefetching data.

### BACKGROUND

A computing system may include a host including one or more processing circuits, such as a central processing unit, a graphics processing unit, and a neural processing unit. The host may also include, or have connected to it, a memory device, which may include one or more memories, having different characteristics.

It is with respect to this general technical environment that aspects of the present disclosure are related.

The above information disclosed in this Background section is only for enhancement of understanding of the background and therefore the information discussed in this Background section does not necessarily constitute prior art.

### SUMMARY

According to an embodiment of the present disclosure, there is provided a method, including: receiving a first read command, the first read command including a first address; receiving a second read command, the second read command including a second address; determining, based on the first address and the second address, that the second read command is a command of a sequence having a first stride; and based on determining that the second read command is a command of a sequence having a first stride, prefetching a first data unit from a first memory to a second memory, the first memory having a first read granularity, and the second memory having a second read granularity, different from the first read granularity.

In some embodiments, the first read granularity is 64 bytes, and the second read granularity is 4096 bytes.

In some embodiments, the first read command is a low-power double data rate command and the method further includes extracting an address from the first read command.

In some embodiments, the determining that the second read command is a command of a sequence having a first stride includes: determining that an entry in a stride history table has a stride value equal to a separation between the second address and the first address; and determining that the entry has a confidence value greater than a threshold.

In some embodiments, the method further includes: in response to determining that an entry in a stride history table has a stride value equal to a separation between the second address and the first address, incrementing the confidence value.

In some embodiments, the prefetching of the first data unit includes prefetching the first data unit from an address, in the first memory, separated from the second address by the first stride.

In some embodiments, the method further includes fetching a second data unit, from the second address.

In some embodiments, the prefetching of the first data unit from the first memory to the second memory includes storing the first data unit in a first-in-first-out structure (FIFO) in the second memory.

In some embodiments, the FIFO is configured to store a plurality of entries, each entry including an address and a prefetched data unit.

In some embodiments, an address in the FIFO is stored in a content-addressable memory.

In some embodiments, the method further includes: receiving a third read command, the third read command including a third address; receiving a fourth read command, the fourth read command including a fourth address; determining, based on the third address and the fourth address, that the fourth read command is a command of a sequence having a stride of one; and based on determining that the fourth read command is a command of a sequence having a stride of one, prefetching a third data unit from the first memory to the second memory.

In some embodiments, the determining that the fourth read command is a command of a sequence having a stride of one includes: determining that an entry in a sequence history table has a predicted address equal to the fourth address; and determining that the entry in the sequence history table has a confidence value greater than a threshold.

In some embodiments, the method further includes: in response to determining that an entry in a sequence history table has a predicted address equal to the fourth address, incrementing the confidence value of the entry in the sequence history table.

In some embodiments, the prefetching of the third data unit includes prefetching the third data unit from an address, in the first memory, separated from the fourth address by one.

In some embodiments, the method further includes fetching a fourth data unit, from the fourth address.

In some embodiments, the prefetching of the third data unit from the first memory to the second memory includes storing the third data unit in a first-in-first-out structure (FIFO) in the second memory.

In some embodiments, the FIFO is configured to store a plurality of entries, each entry including an address and a prefetched data unit.

In some embodiments, an address in the FIFO is stored in a content-addressable memory.

According to an embodiment of the present disclosure, there is provided a method, including: receiving a first read command, the first read command including a first address; receiving a second read command, the second read command including a second address; determining, based on the first address and the second address, that the second read command is a command of a sequence having a stride of one; and based on determining that the second read command is a command of a sequence having a stride of one, prefetching a first data unit from a first memory to a second memory, the first memory having a first read granularity, and the second memory having a second read granularity, different from the first read granularity.

According to an embodiment of the present disclosure, there is provided a system, including: a first memory, having a first read granularity; a second memory having a second read granularity, different form the first read granularity; and a processing circuit, the processing circuit being configured to: receive a first read command, the first read command including a first address; receive a second read command, the second read command including a second address; determine, based on the first address and the second address, that the second read command is a command of a sequence having a first stride; and based on determining that the second read command is a command of a sequence having a first stride, prefetch a first data unit from a first memory to a second memory.

### BRIEF DESCRIPTION OF THE DRAWINGS

These and other features and advantages of the present disclosure will be appreciated and understood with reference to the specification, claims, and appended drawings wherein:

FIG. 1A is a system level block diagram, according to an embodiment of the present disclosure;

FIG. 1B is a block diagram of a host connected to a memory device, according to an embodiment of the present disclosure;

FIG. 2A is a hybrid block and flow diagram of a system and method for unit sequence detection, according to an embodiment of the present disclosure;

FIG. 2B is a hybrid block and flow diagram of a system and method for stride sequence detection, according to an embodiment of the present disclosure;

FIG. 3 is a block diagram of data structures stored in a memory, according to an embodiment of the present disclosure; and

FIGS. 4A and 4B are a flow chart of a method for prefetching, according to an embodiment of the present disclosure.

### DETAILED DESCRIPTION

The detailed description set forth below in connection with the appended drawings is intended as a description of exemplary embodiments of a system and method for prefetching data provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

As mentioned above, a computing system may include a host including one or more processing circuits, such as a central processing unit, a graphics processing unit, and a neural processing unit. The host may also include, or have connected to it, a memory device, which may include one or more memories, having different characteristics. Such a computing system may, in operation, perform operations such as tensor operations (e.g., matrix multiplications) which may involve accessing data elements (e.g., integers, or floating-point numbers) stored at uniformly spaced locations in memory. For example, multiplying a first matrix and second matrix, each stored in row-major order in memory, may involve forming dot products of the rows of the first matrix and the columns of the second matrix. Forming one such dot product, for example, that of the first row vector of the first matrix with the first column vector of the second matrix, may involve reading consecutive memory locations in the area of memory in which the first matrix is stored, and reading non-consecutive, uniformly spaced locations in the area of memory in which the second matrix is stored. For example, if each of the two matrices is a 10×10 matrix, then reading the column vector of the second matrix will involve reading a set of data elements that are uniformly spaced, each data element that is read, after the first one, being spaced from the previously read data element by a separation (or “stride”) of 10 (i.e., there may be 9 intervening data elements, which are not read, between each data element that is read and the previously read data element).

As mentioned above, the host may include, or have connected to it, a memory device, which may include one or more memories, having different characteristics. For example, the memory device may include dynamic random-access memory (DRAM) and nonvolatile memory (e.g., flash memory). The DRAM may be faster (e.g., it may exhibit lower latency or higher throughput) than the nonvolatile memory, and it may be more expensive (e.g., measured by cost per bit of storage) than the nonvolatile memory. In addition to having lower cost per bit, the nonvolatile memory may have the advantage of avoiding data loss in case of a power outage or other hardware failure.

In part because of these characteristics of the nonvolatile memory, significant amounts of data may be stored, by default, in the nonvolatile memory. For example, in a mixture of experts (MOE) large language model, weights (e.g., weights formatted as tensors) of a number of sub-models, each of which may be referred to as an expert, may be stored in the nonvolatile memory. The storage space occupied by these weights may be sufficiently large that it may not be practical to store all of them in the more costly DRAM.

In operation, however, it may advantageous to copy certain weights into the DRAM, when it is anticipated that these weights will be needed for a calculation in the near future. For example, if the CPU is calculating the dot product of a row vector and a column vector, then it may be advantageous to fetch (or “prefetch”) one or more elements of each vector from the nonvolatile memory and save them in the DRAM before they are needed by the CPU, so that the will be available with low latency when the CPU requests them.

The memory device may infer, from patterns in the read instructions that it receives, which elements are expected to be read in the near future. For example, if a number of consecutive memory locations are read in sequence, then the memory device may infer that additional consecutive memory locations may be read in the near future (e.g., because the elements of a row vector (or of a column vector of a matrix stored in column-major form) are being read), and the memory device may prefetch one or more of such additional consecutive memory locations. Such a sequence of consecutive memory locations may be referred to as a “unit sequence”. Similarly, if, for example, a number of data elements from a sequence of uniformly spaced memory locations, separated by a stride, are read in sequence, then the memory device may infer that additional memory locations in the sequence may be read in the near future (e.g., because the elements of a column vector (or of a row vector of a matrix stored in column-major form) are being read), and the memory device may prefetch one or more data elements from such additional memory locations.

A sequence history table may be used to detect sequential access of consecutive memory locations. Each entry in this table may (i) include an address (which may be the “predicted” address of the next memory location in the sequence) and (ii) a confidence value, which may be a value (e.g., an integer) corresponding to the confidence with which it has been determined that previous read operations are part of a sequence. When the memory device receives a read command, it may compare the address to be read with the addresses in the sequence history table, and, if the address of an entry in the sequence history table (e.g., the address of a first entry) matches the address to be read (which may be referred to as the “read address”), the memory device may (i) return the data element at the address to the host, (ii) increase the address of the first entry by the size of the data element, and (iii) increase (e.g., increment by one) the confidence value of the first entry. If the address is not in the sequence history table then the memory device may add the address to the sequence history table as a new entry, setting the confidence value of the new entry to the lowest possible value (e.g., to zero). The sequence history table may be a first-in-first-out data structure (FIFO). As such, adding a new entry at one end of the FIFO (e.g., at the “back” of the FIFO) may result in another entry being removed at the other end of the FIFO (e.g., at the “front” of the FIFO). The confidence value of this other entry may be reduced by a set amount (e.g., by an amount equal to the threshold) and, if, after being reduced by the set amount, the confidence value remains greater than a second threshold (e.g., greater than 0) then the other value may be placed back into the FIFO at the beginning; otherwise the other value may be discarded. This may result in further entries being removed at the front of the FIFO; each such entry may be placed back into the FIFO, if after being reduced, its confidence value exceeds the second threshold, until an entry is discarded.

In a system in which the minimum quantity of data that can be read from the second memory (which may be referred to as a “data unit”) is more than one data element, a unit sequence may be defined as a sequence of read operations of data units that are stored in contiguous regions of memory.

A stride history table may similarly be used to detect sequences in which the data units that are retrieved are separated by intervening data units that are not read. The stride history table may include a plurality of entries each including a stride and a confidence value. As in the case of the sequence history table, the stride history table may be a FIFO, with each entry removed from the front of the FIFO being deleted if, after being decreased, its confidence value is less than the second threshold.

Data stored in the DRAM may be stored in a FIFO, and discarded after being removed from the front of the FIFO, except if a dirty bit, which may be saved in the FIFO along with the data unit, is set (as a result of the data having been modified by a write command), in which case the data may be flushed to the nonvolatile memory and then discarded.

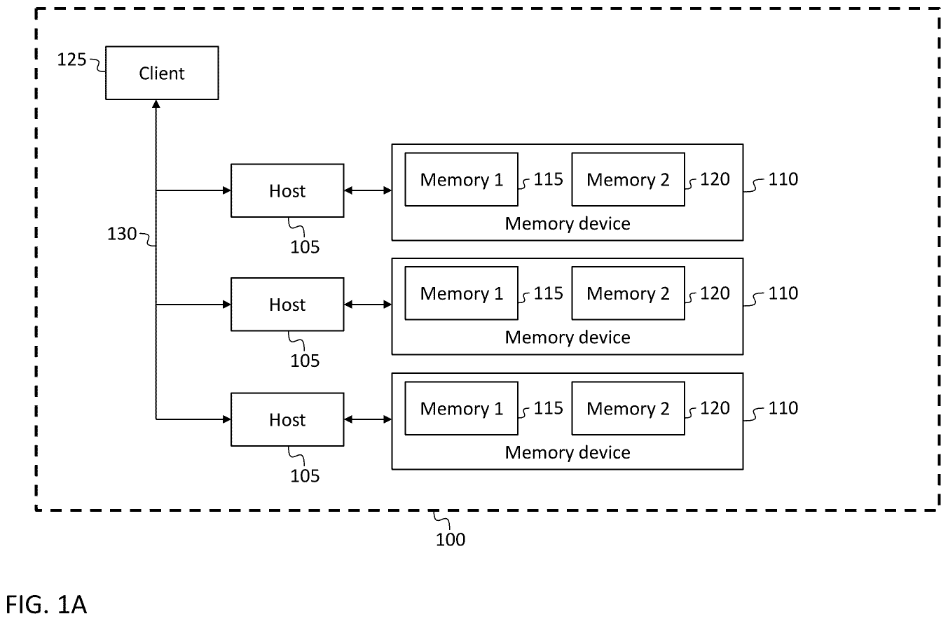

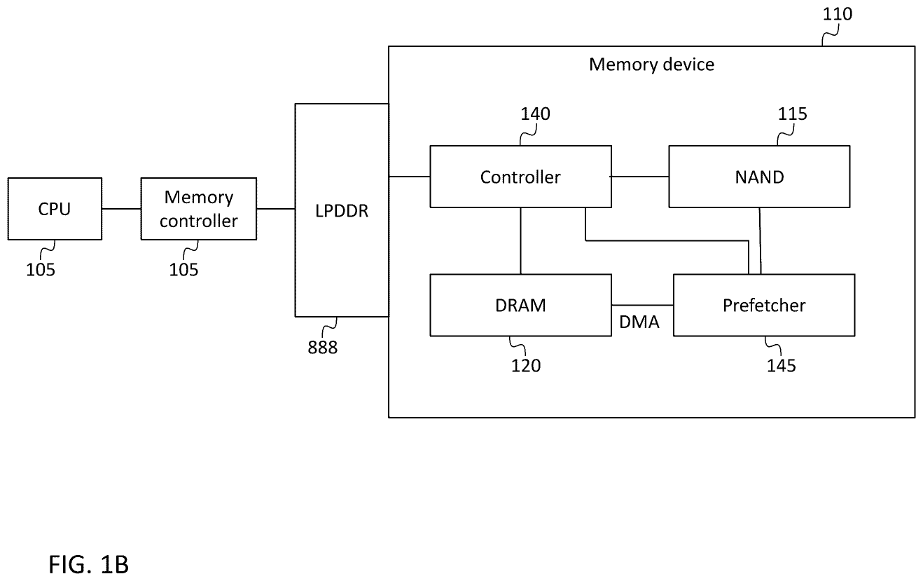

FIG. 1A is a block diagram of a computing system 100. The computing system 100 may include one or more hosts 105, each of which includes one or more processing elements such as a central processing unit (CPU), a graphics processing unit (GPU), or a neural processing unit (NPU). Each host 105 uses a corresponding memory device 110 to retrieve data units for calculations, such as tensor calculations for machine learning models, or to store the results of calculations. During this process, the host 105 may write data units to the memory device 110, and the host 105 may read data units from the memory device 110.

As mentioned above, the memory device may include a first memory 115 and a second memory 120. The first memory 115 may be nonvolatile memory 115 and the second memory may be DRAM 120, as mentioned above. In this disclosure, the terms first memory 115 and nonvolatile memory 115 are used interchangeably and the terms second memory 120 and DRAM 120 are used interchangeably for ease of understanding, but this disclosure is not limited to such embodiments, and each of the first memory 115 and the second memory 120 may be any kind of memory. In some embodiments, the performance, from the perspective of the host 105, of the first memory 115 and the second memory 120 may be different, e.g., because of differences in the storage media (as, for example, in the case of nonvolatile memory 115 and DRAM 120) or because of differences in the nature of (e.g., the latency and bandwidth of) their respective connections to the host 105. Thus, the defining characteristic of the first memory is that it is less responsive to data accesses from the host than the second memory.

A client 125, which may be connected to the host through a network 130 (e.g., via a wired or wireless communication protocol), may send requests (e.g., for higher-level machine learning operations (e.g., inference operations)) to the host 105, and receive results from the host 105. As illustrated in FIG. 1A, the client 125 may be connected to a plurality of hosts 105 providing similar services. Accordingly, the client 125 may send, for example, a request to perform image classification, the request including an image, to a first host 105, and the host may perform the image classification, e.g., using data (e.g., weights) from a memory device 110 to perform tensor operations (e.g., array multiplications) to perform the image classification.

As mentioned above, the DRAM 120 may be faster (e.g., it may exhibit lower latency or higher throughput) than the nonvolatile memory 115, and the DRAM 120 may be more expensive (e.g., measured by cost per bit of storage) than the nonvolatile memory 115. In addition to having lower cost per bit, the nonvolatile memory may have the advantage of avoiding data loss in case of a power outage or other hardware failure.

In part because of these characteristics of the nonvolatile memory, significant amounts of data (such as weights for a machine learning model) may be stored, by default, in the nonvolatile memory 115. The storage space occupied by these weights may be sufficiently large that it may not be practical to store all of them in the more costly DRAM 120 (e.g., by increasing the size of the DRAM 120).

In operation, e.g., when performing a tensor operation, the host 105 may, for example, calculate a dot product of (i) a first vector, which may be a row vector of a matrix that is stored in row-major order and (ii) a second vector (e.g., a column vector of another matrix). Such a calculation may, when retrieving the elements of the first vector, involve reading a sequence of data elements (the elements of the vector (each of which may be, e.g., an integer or a floating point number)) stored in consecutive memory locations. The memory locations may be considered “consecutive” if they are contiguous in memory, regardless of the difference between the addresses of the consecutive data elements. To read these data elements from the memory device, the host 105 may execute a sequence of load instructions each of which may have the effect of reading one data unit from the memory. As used herein, a “data unit” is the amount of data returned to the host 105 when a load instruction is executed. As, such, a data unit may be a cache line (e.g., 64 bytes). The data unit may be a characteristic of both (i) the interface (e.g., a low-power double data rate (LPDDR) interface) connecting the host 105 and the memory device 110 and (ii) the second memory 120 (e.g., the DRAM 120). The read granularity (the smallest quantity of data that can be read in one operation) for the DRAM 120 may be one cache line, and the read granularity for the nonvolatile memory 115 may be one page (which may be 512 bytes, 1024 bytes, 2048 bytes, or 4096 bytes).

FIG. 1B is a block diagram of the memory device 110, showing its connection to a host 105, which in FIG. 1B consists of a CPU. As mentioned above, the host 105 may include one or more graphics processing units (GPUs), or one or more neural processing units (NPUs) instead of, or in addition to, one or more CPUs. As used herein, the host 105 is, for ease of description, considered a separate element from the memory device 110, which sends read and write commands to the memory device 110, even though in some embodiments, the memory device 110 may, for example, share an enclosure with the host 105 or, for example, be constructed on the same printed circuit board as the CPU 105.

In some embodiments, the host 105 is connected to the memory device 110 through a low-power double data rate (LPDDR) interface 135. The memory device 110 may include, in addition to the nonvolatile memory 115 and the DRAM 120, a controller 140 (which may be a processing circuit, e.g., a stored-program computer) and a prefetcher (or “prefetch engine”) 145. The controller 140 and the prefetcher 145 may coordinate the retrieval of data from, and writing of data to, the nonvolatile memory 115 and the DRAM 120 in response to load and store instructions being executed by the CPU 105. The prefetcher 145 may also perform prefetching.

Prefetching may improve the performance of the system when the memory device 110 correctly anticipates that the host 105 will need one or more data units in the near future, and copies these data units into the DRAM 120 from the nonvolatile memory 115 before the host 105 requests these data units. The memory device 110 may perform this anticipation by detecting sequences of read operations that read uniformly spaced elements from the memory device 110. As mentioned above, such reading of uniformly spaced data units may occur when the host performs a tensor operation such as a matrix multiplication, which may involve calculating a dot product of a first vector and a second vector. If the elements are stored in uniformly-spaced non-consecutive (e.g., non-contiguous) locations in memory then the sequence of read operations may be referred to as a “stride sequence”. The “stride” of such a sequence is the separation, in memory, between the locations of successive read operations (which may be defined as the difference between the addresses of any pair of the successive read operations, or as one plus the number of intervening data units, between each pair of successive read operations). As mentioned above, if the elements of one of the vectors are stored in consecutive locations in memory, then the sequence of consecutive data units may be referred to as a “unit sequence” because it is a sequence with a stride of one.

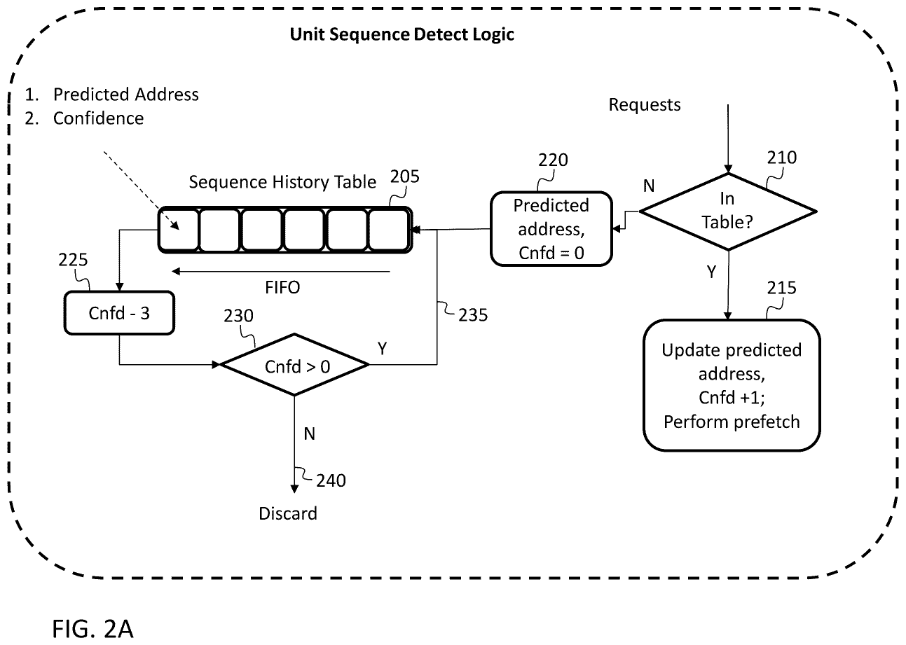

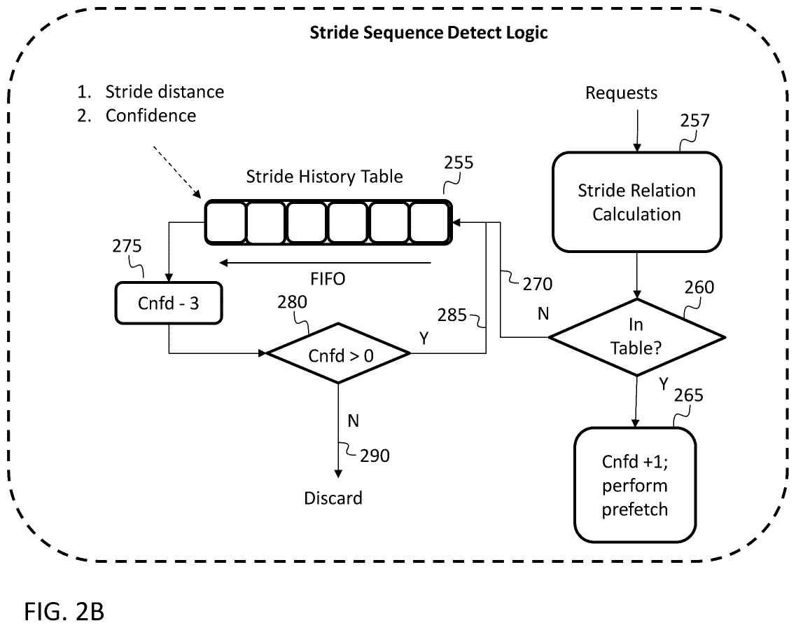

FIG. 2A shows a system and method for unit sequence detection, which may be part of the prefetcher 145. The system includes a sequence history table 205, which is a FIFO each entry of which includes (i) a predicted address and (ii) a confidence value (“Cnfd”). At startup, all of the predicted addresses and all of the confidence values may be initialized to zero.

When a read command is received, the system compares, at 210, the address of the read command (the “read address”) to the addresses saved in the sequence history table 205 (which may be referred to as “predicted addresses” because they are addresses from which has not occurred, but is expected to occur). If the read address is found in the sequence history table 205, then, at 215, the confidence value associated with the read address (e.g., the confidence value that is in the same element of the sequence history table 205 as the address) is increased by 1, and the address of the element of the sequence history table 205 is changed to the new predicted address (which is the address, in memory, of the next contiguous data unit). If the new confidence value is greater than the first threshold, then the prefetcher 145 prefetches the data unit predicted to be read next (the “predicted data unit”). For example the prefetcher 145 reads the page containing the predicted data unit from the nonvolatile memory 115 and saves the data unit at the new predicted address to the DRAM 120. In some embodiments, the prefetcher copies more than one consecutive data unit from the retrieved page to the DRAM 120.

The memory device 110 also retrieves, and returns to the host, the data element at the read address. If the confidence value is greater than the threshold, the memory device checks whether the data unit at the read address is in the DRAM 120. If it is (a situation that may be referred to as a “DRAM hit”), the memory device 110 retrieves the data unit from the DRAM 120, and if it is not (a situation that may be referred to as a “DRAM miss”), the memory device 110 retrieves the data unit from the nonvolatile memory 115. The memory device 110 then returns the data unit to the host.

If, at 210, the read address is not found in the sequence history table 205, the prefetcher 145 adds, at 220 a new entry to the back of the sequence history table 205, the new entry containing the next predicted address (e.g., the address of the data unit following the data unit at the read address) and a confidence value of 0. The sequence history table 205 may be, as mentioned above, a FIFO (e.g., a FIFO having a size that is within 50% of 2 MB). As such, adding a new entry (e.g., a first entry) at the back of the FIFO may result in another entry (e.g., a second entry) being removed at the front of the FIFO. When this occurs, the confidence value of the second entry may be reduced, at 225, by a set amount (e.g., by an amount equal to the threshold, e.g., by 3, as shown) and, if, after being reduced by the set amount, the confidence value remains greater than a second threshold (e.g., greater than 0), as determined at 230, then the second entry may be placed, at 235, back into the FIFO at the back of the FIFO; otherwise the second entry may be discarded, at 240. Placing the second entry back into the FIFO may result in further entries being removed at the front of the FIFO; each such entry may be placed back into the FIFO, if after being reduced, its confidence value exceeds the second threshold, until an entry is discarded.

As mentioned above, all of the predicted addresses and all of the confidence values may be initialized to zero at startup. The operation of the memory device 110 after startup may be illustrated by a first example in which, after startup, the memory device receives a sequence of read commands having read addresses that form a unit sequence. In such an example, the first read command received after startup may have a read address that is not in the sequence history table 205, and, as such, the prefetcher 145 may add (e.g., at 220), a new entry, at the back of the sequence history table 205, the new entry containing the next predicted address (e.g., the address of the data unit following the data unit at the read address) and a confidence value of 0. The next read command may then have a read address equal to the predicted address, causing the prefetcher 145 to increase the confidence value of the new entry. The memory device 110 may also retrieve, and return to the host 105, the data element at the read address. This process may be repeated (with the confidence value being increased with each additional read command received) until the confidence value exceeds the first threshold. For this read command and those that follow, the prefetcher may also (in addition to the operations described above) prefetch the data unit predicted to be read next.

FIG. 2B shows a system and method for stride sequence detection, which also may be part of the prefetcher 145. The system includes a stride history table 255, which is a FIFO each entry of which includes (i) a stride value and (ii) a confidence value. At startup, all of the stride values and all of the confidence values may be initialized to zero.

When a read command is received, the prefetcher 145 calculates a stride, at 257, by subtracting, from the current read address, the last address read (which may be stored in a last read address register of the prefetcher 145). The last read address register may be set to zero at startup. The prefetcher 145 then compares, at 260, the stride to the strides in the stride history table 255. If the stride is found in the stride history table 255, then, at 265, the confidence value associated with the stride (e.g., the confidence value that is in the same element of the stride history table 255 as the stride) is increased by 1. If the new confidence value is greater than the first threshold, then the prefetcher 145 prefetches the data unit predicted to be read next (the “predicted data unit”), which may be the data unit at an address beyond the read address by the stride. For example, the prefetcher 145 reads the page containing the predicted data unit from the nonvolatile memory 115 and saves the data unit at the new predicted address to the DRAM 120. In some embodiments, the prefetcher copies more than one data unit (e.g., it copies all of the data units that are in the stride sequence and in the page) from the retrieved page to the DRAM 120.

The memory device 110 also retrieves, and returns to the host 105, the data element at the read address. If the confidence value is greater than the first threshold, the memory device checks whether the data unit at the read address is in the DRAM 120. If it is (a situation that may be referred to as a “DRAM hit”), the memory device 110 retrieves the data unit from the DRAM 120, and if it is not (a situation that may be referred to as a “DRAM miss”), the memory device 110 retrieves the data unit from the nonvolatile memory 115. The memory device 110 then returns the data unit to the host 105.

If, at 260, the stride is not found in the stride history table 255, the prefetcher 145 adds, at 270 a new entry to the back of the stride history table 255, the new entry containing the stride and a confidence value of 0. The stride history table 255 may be, as mentioned above, a FIFO (e.g., a FIFO having a size that is within 50% of 2 MB). As such, adding a new entry (e.g., a first entry) at the back of the FIFO may result in another entry (e.g., a second entry) being removed at the front of the FIFO. When this occurs, the confidence value of the second entry may be reduced, at 275, by a set amount (e.g., by an amount equal to the first threshold, e.g., by 3, as shown) and, if, after being reduced by the set amount, the confidence value remains greater than a second threshold (e.g., greater than 0), as determined at 280, then the second entry may be placed, at 285, back into the FIFO at the back of the FIFO; otherwise the second entry may be discarded, at 290. Placing the second entry back into the FIFO may result in further entries being removed at the front of the FIFO; each such entry may be placed back into the FIFO, if after being reduced, its confidence value exceeds the second threshold, until an entry is discarded.

As mentioned above, (i) the last read address register of the prefetcher 145, (ii) a of the stride values of the stride history table 255, and (iii) all of the confidence values stride history table 255 may be initialized to zero at startup. The operation of the memory device 110 after startup may be further illustrated by a second example in which, after startup, the memory device receives a sequence of read commands having read addresses that form a stride sequence. In such an example, when the first read command is received after startup, the prefetcher 145 may (e.g., at 257) calculate a stride by subtracting the value of the last read address register of the prefetcher 145 (a value that, at startup, is zero) from the current read address. The calculated stride may differ from the (zero) strides stored in the stride history table 255, and, as such, the stride is not found (e.g., at 260) in the stride history table 255. The prefetcher 145 then adds, at 270 a new entry to the back of the stride history table 255, the new entry containing the calculated stride and a confidence value of 0. The memory device 110 may also retrieve, and return to the host 105, the data element at the read address.

The calculated stride, being the difference between the first read address in the stride sequence and zero, is, in general, not the stride of the stride sequence. As such, when a second read command is received, the second read command having a read address differing from the previously received read address by the true stride, the prefetcher calculates the true stride (which also is not in the stride history table 255), and adds a second entry to the stride history table 255, the second entry including the newly calculated (true) stride and a confidence value of 0. As in the case for the first read command received, the memory device 110 may also retrieve, and return to the host 105, the data element at the read address.

The confidence value is then increased each time another read command with the same stride is received, until the confidence value exceeds the first threshold, at which point the prefetcher begins to prefetch the predicted data unit or units (in addition to increasing the confidence value, and returning the requested data value to the host 105).

The prefetcher 145 may be a processing circuit. In some embodiments, the prefetcher is a state machine that is not a stored program computer. In such an implementation the state machine may have higher throughput than a stored program computer running at the same clock speed, in part because it may avoid incurring the overhead associated with retrieving instructions from memory and interpreting the instructions.

In some embodiments, the confidence threshold may be 3 for both unit sequence detection and for stride sequence detection. In some embodiments, the confidence thresholds may be different in unit sequence detection and in stride sequence detection (e.g., different from 3, or different from each other). In some embodiments, the host 105 may use a Double Data Rate Transaction (DDR-T) protocol to avoid time-outs that otherwise may occur when the host 105 sends a read command that results in a DRAM miss. In some embodiments, the memory device 110 has a Dual In-line Memory Module (DIMM) form factor.

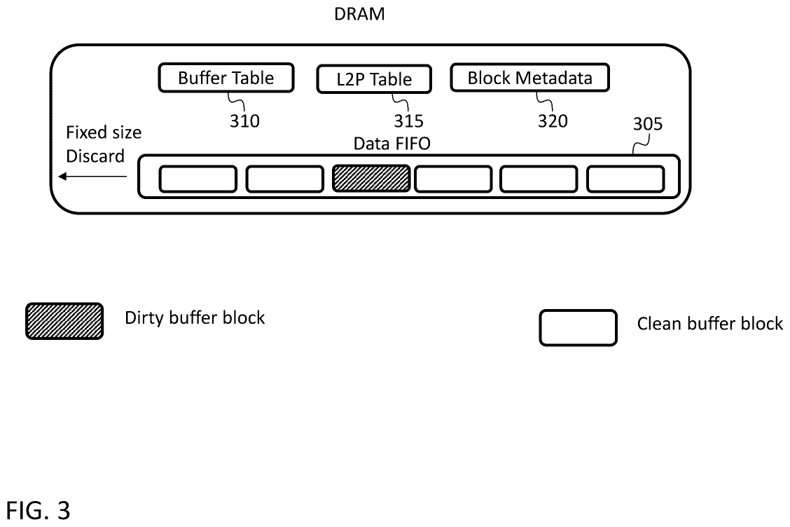

FIG. 3 shows data structures in the DRAM 120, in some embodiments. Data prefetched from the nonvolatile memory 115 may be placed into the back of a data FIFO 305. Once the data FIFO 305 is full, each time a new data unit is added to the data FIFO 305, a data unit may be removed from the front of the data FIFO 305 and, if the dirty bit for the data unit is not set, discarded. The dirty bit may become set for a data unit in the data FIFO 305 if a write command is received from the host 105 (e.g., if the host 105 executes a store instruction), affecting the data unit, while the data unit is in the data FIFO 305. A dirty bit may be stored in the data FIFO 305 along with each data unit in the data FIFO 305. The data FIFO 305 may periodically be checked for set dirty bits, and, if any are found (or if a data unit being removed from the front of the data FIFO 305 has a dirty bit that is set) the modified value may be written back to the nonvolatile memory 115 (and the dirty bit may be cleared, if the data unit remains in the data FIFO 305).

A buffer table 310 may store the address of each data unit in the data FIFO 305. The buffer table 310 may also be a FIFO, and it may be synchronized with the data FIFO 305 (e.g., an address may be added to the buffer table 310 whenever a data unit is added to the buffer table 310, and the buffer table 310 may have the depth as the data FIFO 305). In some embodiments, the buffer table 310 is in the DRAM 120 as shown; in other embodiments it is in a separate, content-addressable memory (which may be a third memory of the memory device 110). Such an embodiment may significantly reduce the time required to determine whether a given data unit is in the DRAM 120.

The DRAM may also include a logical to physical (L2P) table 315 for translating addresses received from the host 105 to addresses in the nonvolatile memory 115 and a block metadata table 320 for tracking of erasures and read-disturb values.

Some embodiments may improve the functioning of a computer including, or connected to, a memory device 110 as disclosed herein. For example, compared to a system in which a memory device includes only a first memory (e.g., a nonvolatile memory 115), or compared to a system in which a memory device includes a second memory (e.g., a DRAM 120) but does not perform prefetching from the first memory 115 into the second memory 120, embodiments of the present disclosure provide improved latency or improved throughput when a data unit is prefetched from the first memory 115 into the second memory 120. Such performance improvements may be realized when the data unit is subsequently read by the host 105. Further, compared to a system in which prefetching performed only based on spatial locality (e.g., in which data units are copied based only on whether they are at addresses near a recently read data unit) embodiments of the present disclosure provide improved latency or improved throughput when a data unit is prefetched from a memory location that is not near, but separated by a stride, from a recently read data unit. Such performance improvements may be realized when the data unit is subsequently read by the host 105. Further (unlike a host-managed prefetch system (e.g., a system in which the host 105 may send prefetch instructions to a memory device)), some embodiments may be completely in-device, and may require no participation from the host 105 (e.g., the host 105 and the interface between the host 105 and the memory device 110 may be the same as in a system in which the memory device 110 does not perform prefetching).

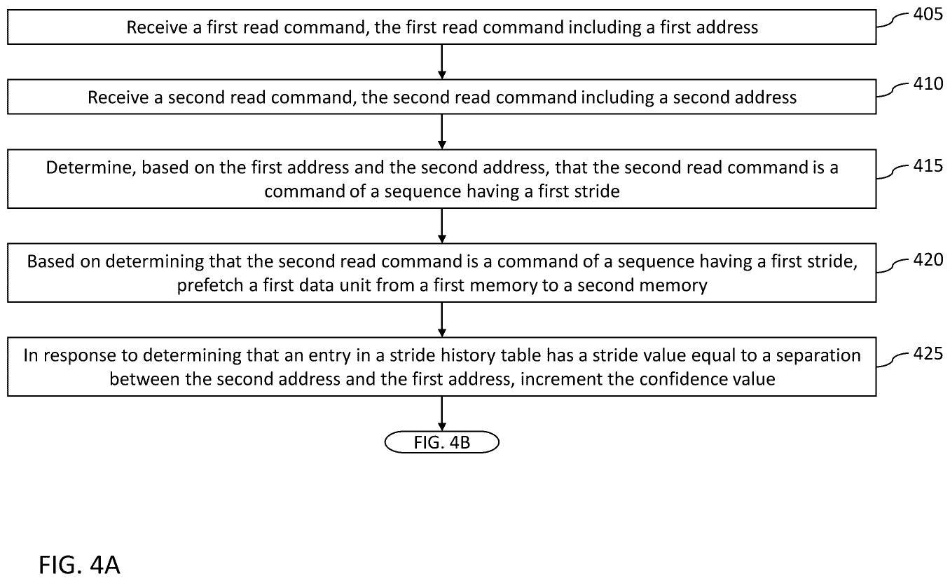

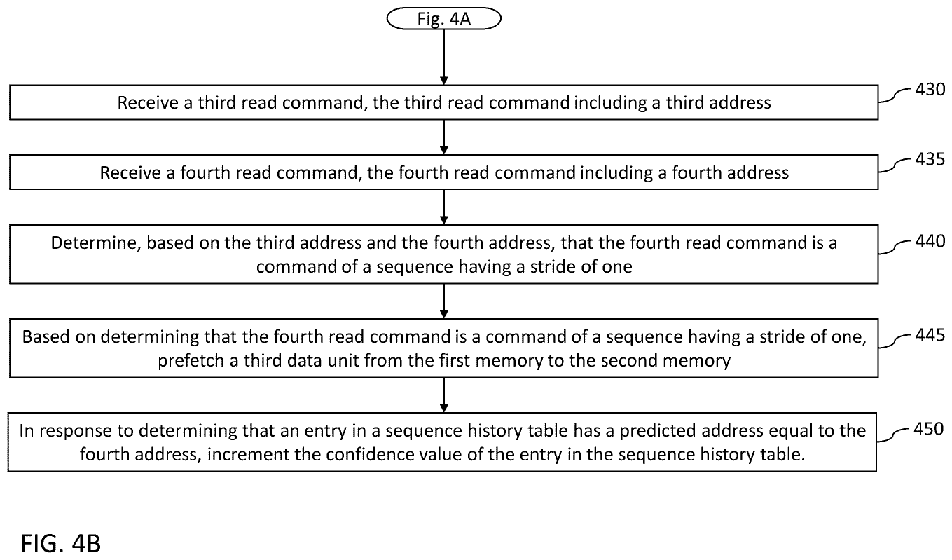

FIGS. 4A and 4B shows a method of prefetching, in some embodiments. Although FIGS. 4A and 4B illustrate various operations in such a method, embodiments according to the present disclosure are not limited thereto. For example, according to some embodiments, such a method may include additional operations or fewer operations, or the order of operations may vary (unless otherwise explicitly stated or implied) without departing from the spirit and scope of embodiments according to the present disclosure.

The method includes receiving, at 405, a first read command, the first read command including a first address; receiving, at 410, a second read command, the second read command including a second address; determining, at 415, based on the first address and the second address, that the second read command is a command of a sequence having a first stride; and, at 420, based on determining that the second read command is a command of a sequence having a first stride, prefetching a first data unit from a first memory to a second memory, the first memory having a first read granularity, and the second memory having a second read granularity, different from the first read granularity. For example, as mentioned above, in the context of FIG. 2B, a stride sequence may be detected based on a sequence of read commands having uniformly spaced addresses, the address spacing being the stride. In response to detecting the stride sequence, the prefetcher 145 may prefetch a data unit (e.g., a data unit at a third address, separated from the second address by the stride) from the nonvolatile memory 115 to the DRAM 120.

In some embodiments, the first read granularity is 64 bytes, and the second read granularity is 4096 bytes. In some embodiments, the first read command is a low-power double data rate (LPDDR) command, and the method further includes extracting an address from the first read command. For example, as discussed above, the memory device 110 may translate the LPDDR signals it receives into read commands in an internal format used by the memory device 110, each of which may include a read address, from which a data unit is to be read. In some embodiments, the determining that the second read command is a command of a sequence having a first stride comprises: determining that an entry in a stride history table has a stride value equal to a separation between the second address and the first address; and determining that the entry has a confidence value greater than a threshold. For example, as discussed above in the context of FIG. 2B, if the prefetcher 145 finds the stride (calculated as the difference between the current read address and the previous read address) in the stride history table 255, and if the corresponding entry has a confidence value exceeding the threshold, the prefetcher 145 may determine that a stride sequence has been detected, and it may, accordingly, fetch the next data unit in the sequence.

The method further includes, at 425, in response to determining that an entry in a stride history table has a stride value equal to a separation between the second address and the first address, incrementing the confidence value. For example, as discussed above in the context of FIG. 2B, if the prefetcher 145 finds the stride (calculated as the difference between the current read address and the previous read address) in the stride history table 255 it may increment the corresponding confidence value. In some embodiments, the prefetching of the first data unit comprises prefetching the first data unit from an address (e.g., the third address), in the first memory, separated from the second address by the first stride. In some embodiments, the method further includes fetching a second data unit, from the second address. For example, before or after prefetching the data value from the third address, the memory device 110 may also fetch (from the nonvolatile memory 115 or from the DRAM 120), the data unit at the read address, and return it to the host 105. In some embodiments, the prefetching a first data unit from the first memory to the second memory comprises storing the first data unit in a first-in-first-out structure (FIFO) (e.g., in the data FIFO 305 of FIG. 3) in the second memory. In some embodiments, the FIFO (e.g., the data FIFO 305) is configured to store a plurality of entries, each entry comprising an address and a prefetched data unit. In some embodiments, an address in the FIFO is stored in a content-addressable memory.

The method further includes receiving, at 430, a third read command, the third read command including a third address; receiving, at 435, a fourth read command, the fourth read command including a fourth address; determining, at 440, based on the third address and the fourth address, that the fourth read command is a command of a sequence having a stride of one; at 445, based on determining that the fourth read command is a command of a sequence having a stride of one, prefetching a third data unit from the first memory to the second memory. For example, as discussed above in the context of FIG. 2A, a unit sequence may be detected based on a sequence of read commands having uniformly spaced addresses, the address spacing being one (e.g., one data unit). In response to detecting the unit sequence, the prefetcher 145 may prefetch a data unit (e.g., a data unit at a third address, separated from the second address by one) from the nonvolatile memory 115 to the DRAM 120. In some embodiments, the determining that the fourth read command is a command of a sequence having a stride of one comprises: determining that an entry in a sequence history table has a predicted address equal to the fourth address; and determining that the entry in the sequence history table has a confidence value greater than a threshold. For example, as described in the context of FIG. 2A, the prefetcher 145 may determine that a unit sequence has been detected when the current read address equals an address in the sequence history table 205 and the corresponding confidence value exceeds the first threshold.

The method further includes, at 450, in response to determining that an entry in a sequence history table has a predicted address equal to the fourth address, incrementing the confidence value of the entry in the sequence history table. For example, as discussed above in the context of FIG. 2A, if the prefetcher 145 finds the read address in the sequence history table 205, it may increment the corresponding confidence value. In some embodiments, the prefetching of the third data unit comprises prefetching the third data unit from an address, in the first memory, separated from the fourth address by one. For example, as discussed in the context of FIG. 2A, when the determine that a unit sequence has been detected, it may prefetch the next data unit in the sequence. In some embodiments, the method further includes fetching a fourth data unit, from the fourth address. For example, before or after prefetching the data value from the third address, the memory device 110 may also fetch (from the nonvolatile memory 115 or from the DRAM 120), the data unit at the read address, and return it to the host 105. In some embodiments, the prefetching of the third data unit from the first memory to the second memory includes storing the third data unit in a first-in-first-out structure (FIFO) in the second memory. In some embodiments, the FIFO is configured to store a plurality of entries, each entry comprising an address and a prefetched data unit. In some embodiments, an address in the FIFO is stored in a content-addressable memory.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, when a second quantity is “within Y” of a first quantity X, it means that the second quantity is at least X−Y and the second quantity is at most X+Y. As used herein, when a second number is “within Y %” of a first number, it means that the second number is at least (1−Y/100) times the first number and the second number is at most (1+Y/100) times the first number. As used herein, the term “or” should be interpreted as “and/or”, such that, for example, “A or B” means any one of “A” or “B” or “A and B”.

The background provided in the Background section of the present disclosure section is included only to set context, and the content of this section is not admitted to be prior art. Any of the components or any combination of the components described (e.g., in any system diagrams included herein) may be used to perform one or more of the operations of any flow chart included herein. Further, (i) the operations are example operations, and may involve various additional steps not explicitly covered, and (ii) the temporal order of the operations may be varied.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that such spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1−35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

Some embodiments may include features of the following numbered statements.
1. A method, comprising:
   receiving a first read command, the first read command including a first address;
   receiving a second read command, the second read command including a second address;
   determining, based on the first address and the second address, that the second read command is a command of a sequence having a first stride; and
   based on determining that the second read command is a command of a sequence having a first stride, prefetching a first data unit from a first memory to a second memory,
   the first memory having a first read granularity, and the second memory having a second read granularity, different from the first read granularity.
2. The method of statement 1, wherein the first read granularity is 64 bytes, and the second read granularity is 4096 bytes.
3. The method of statement 1 or statement 2, wherein the first read command is a low-power double data rate command and the method further includes extracting an address from the first read command.
4. The method of any one of the preceding statements, wherein the determining that the second read command is a command of a sequence having a first stride comprises:
   determining that an entry in a stride history table has a stride value equal to a separation between the second address and the first address; and
   determining that the entry has a confidence value greater than a threshold.
5. The method of statement 4, further comprising:
   in response to determining that an entry in a stride history table has a stride value equal to a separation between the second address and the first address, incrementing the confidence value.
6. The method of any one of the preceding statements, wherein the prefetching of the first data unit comprises prefetching the first data unit from an address, in the first memory, separated from the second address by the first stride.
7. The method of any one of the preceding statements, further comprising fetching a second data unit, from the second address.
8. The method of any one of the preceding statements, wherein the prefetching of the first data unit from the first memory to the second memory comprises storing the first data unit in a first-in-first-out structure (FIFO) in the second memory.
9. The method of statement 8, wherein the FIFO is configured to store a plurality of entries, each entry comprising an address and a prefetched data unit.
10. The method of statement 8 or statement 9, wherein an address in the FIFO is stored in a content-addressable memory.
11. The method of any one of the preceding statements, further comprising:
   receiving a third read command, the third read command including a third address;
   receiving a fourth read command, the fourth read command including a fourth address;
   determining, based on the third address and the fourth address, that the fourth read command is a command of a sequence having a stride of one; and
   based on determining that the fourth read command is a command of a sequence having a stride of one, prefetching a third data unit from the first memory to the second memory.
12. The method of statement 11, wherein the determining that the fourth read command is a command of a sequence having a stride of one comprises:
   determining that an entry in a sequence history table has a predicted address equal to the fourth address; and
   determining that the entry in the sequence history table has a confidence value greater than a threshold.
13. The method of statement 12, further comprising:
   in response to determining that an entry in a sequence history table has a predicted address equal to the fourth address, incrementing the confidence value of the entry in the sequence history table.
14. The method of any one of statements 11 to 13, wherein the prefetching of the third data unit comprises prefetching the third data unit from an address, in the first memory, separated from the fourth address by one.
15. The method of any one of statements 11 to 14, further comprising fetching a fourth data unit, from the fourth address.
16. The method of any one of statements 11 to 15, wherein the prefetching of the third data unit from the first memory to the second memory comprises storing the third data unit in a first-in-first-out structure (FIFO) in the second memory.
17. The method of statement 16, wherein the FIFO is configured to store a plurality of entries, each entry comprising an address and a prefetched data unit.
18. The method of statement 16 or statement 17, wherein an address in the FIFO is stored in a content-addressable memory.
19. A method, comprising:
   receiving a first read command, the first read command including a first address;
   receiving a second read command, the second read command including a second address;
   determining, based on the first address and the second address, that the second read command is a command of a sequence having a stride of one; and
   based on determining that the second read command is a command of a sequence having a stride of one, prefetching a first data unit from a first memory to a second memory,
   the first memory having a first read granularity, and the second memory having a second read granularity, different from the first read granularity.
20. A system, comprising:
   a first memory, having a first read granularity;
   a second memory having a second read granularity, different form the first read granularity; and
   a processing circuit,
   the processing circuit being configured to:
      receive a first read command, the first read command including a first address;
      receive a second read command, the second read command including a second address;
      determine, based on the first address and the second address, that the second read command is a command of a sequence having a first stride; and
      based on determining that the second read command is a command of a sequence having a first stride, prefetch a first data unit from a first memory to a second memory.

Although exemplary embodiments of a system and method for prefetching data have been specifically described and illustrated herein, many modifications and variations will be apparent to those skilled in the art. Accordingly, it is to be understood that a system and method for prefetching data constructed according to principles of this disclosure may be embodied other than as specifically described herein. The invention is also defined in the following claims, and equivalents thereof.

What is claimed is:

1. A method, comprising:
receiving a first read command, the first read command including a first address;
receiving a second read command, the second read command including a second address;
determining, based on the first address and the second address, that the second read command is a command of a sequence having a first stride; and
based on determining that the second read command is a command of a sequence having a first stride, prefetching a first data unit from a first memory to a second memory,
the first memory having a first read granularity, and the second memory having a second read granularity, different from the first read granularity.

2. The method of claim 1, wherein the first read granularity is 64 bytes, and the second read granularity is 4096 bytes.

3. The method of claim 1, wherein the first read command is a low-power double data rate command and the method further includes extracting an address from the first read command.

4. The method of claim 1, wherein the determining that the second read command is a command of a sequence having a first stride comprises:
determining that an entry in a stride history table has a stride value equal to a separation between the second address and the first address; and
determining that the entry has a confidence value greater than a threshold.

5. The method of claim 4, further comprising:
in response to determining that an entry in a stride history table has a stride value equal to a separation between the second address and the first address, incrementing the confidence value.

6. The method of claim 1, wherein the prefetching of the first data unit comprises prefetching the first data unit from an address, in the first memory, separated from the second address by the first stride.

7. The method of claim 6, further comprising fetching a second data unit, from the second address.

8. The method of claim 1, wherein the prefetching of the first data unit from the first memory to the second memory comprises storing the first data unit in a first-in-first-out structure (FIFO) in the second memory.

9. The method of claim 8, wherein the FIFO is configured to store a plurality of entries, each entry comprising an address and a prefetched data unit.

10. The method of claim 9, wherein an address in the FIFO is stored in a content-addressable memory.

11. The method of claim 1, further comprising:
receiving a third read command, the third read command including a third address;
receiving a fourth read command, the fourth read command including a fourth address;
determining, based on the third address and the fourth address, that the fourth read command is a command of a sequence having a stride of one; and
based on determining that the fourth read command is a command of a sequence having a stride of one, prefetching a third data unit from the first memory to the second memory.

12. The method of claim 11, wherein the determining that the fourth read command is a command of a sequence having a stride of one comprises:
determining that an entry in a sequence history table has a predicted address equal to the fourth address; and
determining that the entry in the sequence history table has a confidence value greater than a threshold.

13. The method of claim 12, further comprising:
in response to determining that an entry in a sequence history table has a predicted address equal to the fourth address, incrementing the confidence value of the entry in the sequence history table.

14. The method of claim 11, wherein the prefetching of the third data unit comprises prefetching the third data unit from an address, in the first memory, separated from the fourth address by one.

15. The method of claim 14, further comprising fetching a fourth data unit, from the fourth address.

16. The method of claim 11, wherein the prefetching of the third data unit from the first memory to the second memory comprises storing the third data unit in a first-in-first-out structure (FIFO) in the second memory.

17. The method of claim 16, wherein the FIFO is configured to store a plurality of entries, each entry comprising an address and a prefetched data unit.

18. The method of claim 17, wherein an address in the FIFO is stored in a content-addressable memory.

19. A method, comprising:
receiving a first read command, the first read command including a first address;
receiving a second read command, the second read command including a second address;
determining, based on the first address and the second address, that the second read command is a command of a sequence having a stride of one; and
based on determining that the second read command is a command of a sequence having a stride of one, prefetching a first data unit from a first memory to a second memory,
the first memory having a first read granularity, and the second memory having a second read granularity, different from the first read granularity.

20. A system, comprising:
a first memory, having a first read granularity;
a second memory having a second read granularity, different form the first read granularity; and
a processing circuit,
the processing circuit being configured to:
receive a first read command, the first read command including a first address;
receive a second read command, the second read command including a second address;
determine, based on the first address and the second address, that the second read command is a command of a sequence having a first stride; and
based on determining that the second read command is a command of a sequence having a first stride, prefetch a first data unit from a first memory to a second memory.
